(19) United States
(12) Patent Application Publication
(10) Pub. No.: US 2002/0071047 A1
(43) Pub. Date: Jun. 13, 2002

(54) Sight enhancement device

(76) Inventors: Graham Strong, Waterloo (CA); Dave Bevers, Waterloo (CA)

Correspondence Address: Orange & Chari, Toronto Dominion Bank Tower, Suite 4900, P.O. Box 190, Toronto, ON, M5K 1H6, CA

(21) Appl. No.: 09/731,061

(22) Filed: Dec. 7, 2000

(51) Int. Cl. H04N 5/222

(52) U.S. Cl. 348/333.02

(57) ABSTRACT

A digital video telescope to support a person with vision impairment, due to adjacent target objects being too small, too distant, or too poorly contrasted to be adequately perceived. The user of the telescope provides real-time image processing with a variable zoom control to locate and magnify the target object and use a contrast enhancement feature to clarify and therefore identify the object. The telescope has additional features that facilitate the real-time processing of object images in adverse viewing situations, such as low light conditions and high levels of background light conditions. The telescope allows the user to dynamically tune out distracting information present in the image and concentrate on desirable feature of the object represented by the image, so as to facilitate object perception and recognition.

### BACKGROUND OF THE INVENTION

A person's visual ability depends upon his or her biological visual system, including the eyes and associated neural connections. Visual ability can range from no light perception to low vision to normal vision to super normal vision. No light perception exists in persons where one or more of the essential components of their visual system is substantially non-functional. Low vision exists in persons with one or more serious impairments in an otherwise functioning visual system. These impairments can affect the person's general abilities in reading, character recognition, and navigation tasks. Thus, a low vision person perceives light and interprets visual information, but these are diminished to a level, which prevents the low vision person from perceiving the visual information in an acceptable manner. Normal vision exists in persons with generally functional visual systems, with either 20/20 vision or some moderate impairment, which can be readily improved with refractive correction by corrective lenses, surgical intervention, or medical treatment. Supra normal vision is where persons have visual capabilities that exceed accepted normal vision perception, such as enhanced night vision.

There are a variety of well-known optical instruments which can be used to enhance or modify the average visual ability of the person. Once such device is a night vision system, which is essentially a light amplification system using available light. This system can also operate further into the infra-red spectrum as compared to the visual capabilities of the average person. Disadvantages with the night vision system are that contrast and focusing of a captured image is not dynamic, and that the system is typically phosphorus based. Accordingly, the night vision system is not suitable for operation in normal light conditions and therefore the visible range of the system is limited.

Other optical instruments to enhance visual abilities are those that rely upon lenses, prisms, and mirrors to enhance the image of a viewed object to a person, in order to compensate for limitations in the person's visual system. These optical instruments can include eyeglasses, binoculars, magnifiers, and telescopes. For example, eyeglasses can correct for focusing difficulties such as far sightedness and near sightedness in low vision and normal vision persons, The optical instruments can also include tinted lenses and polarized lenses to eliminate glare and yellow tinting to facilitate improvements in contrast. However, these optical instruments are not dynamically tunable in response to individual situations, which need compensation for poor vision in adverse viewing conditions such as low light, back lighting, and subtle contrast situations.

Hand held video camera recorders or cam-corders are also used to record and process visual images. For example, cam-corders offer automatic focus and variable magnification. However, cam-corders are principally directed to recording the truest representation of captured visual images, and thus their image processing operations are directed to completing this task, rather than providing an enhanced viewing experience to a person. The resolution of available cam-corder displays, typically attached to the cam-corder, are intended to direct the cam-corder operator for camera positioning and focusing. However, can-corders do not provide image enhancement and magnification features to facilitate the performance of general tasks such as reading and navigation by low vision persons, Another difficulty with cam-corders is that the view finder typically has a field of vision of about 25 to 30 degrees or less, which is suitable in capturing an image but unsuitable for enhancing an image for the purposes of navigation, image recognition, or reading tasks.

One option for processing of video image signals obtained from the cam-corder is through the use of closed circuit television systems. These systems include a camera held by a person and a display or portable monitor, which can be used to further manipulate the captured images from the camera. Typical image editors, such as Photo Shop, can then be used to enhance viewing characteristics of the captured image on the display. One disadvantage of this system is that a person must coordinate movement of the camera while looking at the display to capture and process images, which is undesirable in text reading applications. Furthermore, available image editors in combination with this system do not allow for the real time processing of the captured images, which would be needed for navigation tasks.

A further option for electronic low vision enhancement is an “Electro-Optical Head-Mounted Low Vision Enhancement” device, published by Practical Optometry, 9:6, R. W. Massof, PHD, 1998, which proposed a head-mounted binocular device capable of compensating for visual impairments while accommodating different task requirements. The device captures a visual image in a video format and performs various image processing operations on the video format using optics, in order to present a more comphrensible and/or perceptible image to the eyes of the low vision user. However, the head mounted nature of the device can be awkward and cosmetically unacceptable to the user. Furthermore, this system processes the captured images using a video format and therefore may not be compatible with real time digital processing technology.

A further common disadvantage, in regards to the above described prior art systems and devices, is that the optical hardware equipment is used to enhance the captured image in the video format. This type of processing can be static and not very responsive dynamically in respect to user enhancement preferences. Additionally, use of optical equipment for image enhancement can result in a bulky apparatus that may be awkward to use, as well as power consumption intensive. This can lead to undesirable battery size and life limitations, as well as limiting practical fictional enhancement capabilities of the apparatus.

It is an object of the present invention to provide a sight enhancement device which obviates or mitigates some of the above presented disadvantages.

### SUMMARY OF THE INVENTION

According to the present invention there is provided a computer image display device for digitally augmenting and displaying in substantially real time a captured image. The device comprises an image acquisition assembly for acquiring the captured image and producing a digital image representing the captured image. The device also includes a processor for digitally augmenting a selected characteristic of the digital image to produce an augmented digital image. The device also has a display assembly for displaying the augmented digital image.

### BRIEF DESCRIPTION OF THE DRAWINGS

These and other features of the preferred embodiments of the present invention will become more apparent by way of example only in reference to the following drawings, in which:

FIG. 1 is a side view of the sight enhancement device;

FIG. 2 is a front perspective view of the device of FIG. 1;

FIG. 3 is a schematic of components of the processor of the device of FIG. 1; and

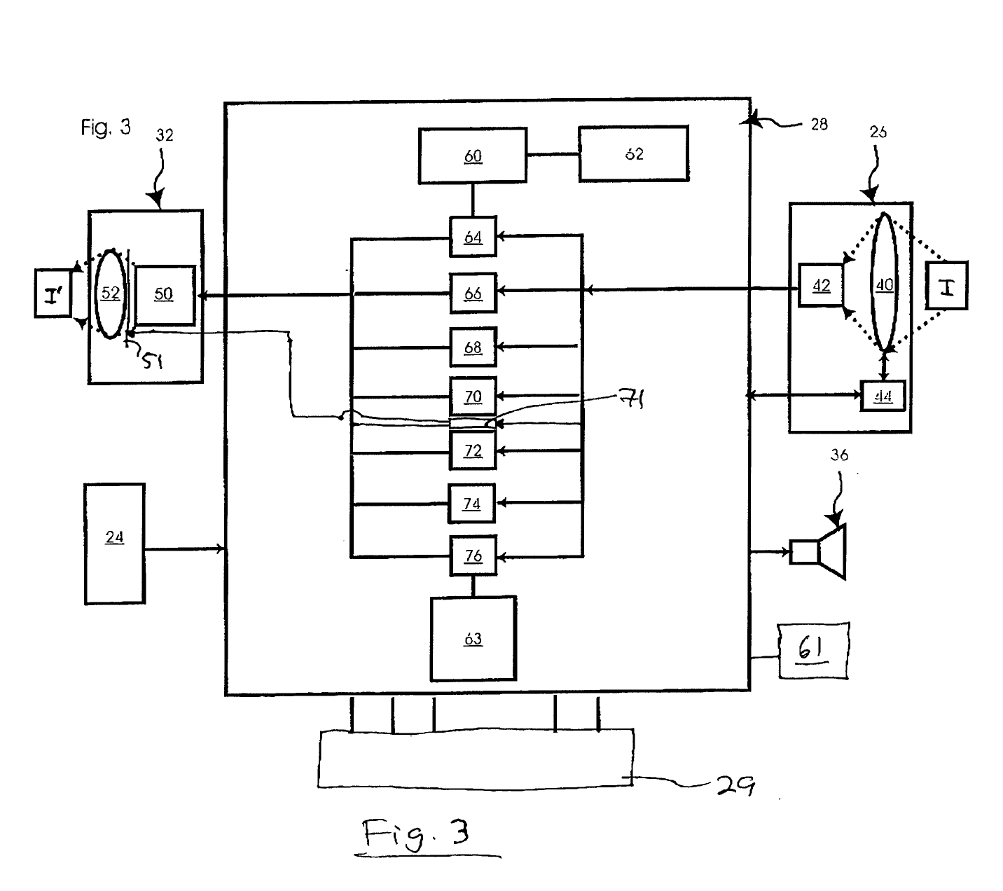

FIG. 4 is a schematic of components of the device of FIG. 1.

### DESCRIPTION OF THE PREFERRED EMBODIMENTS

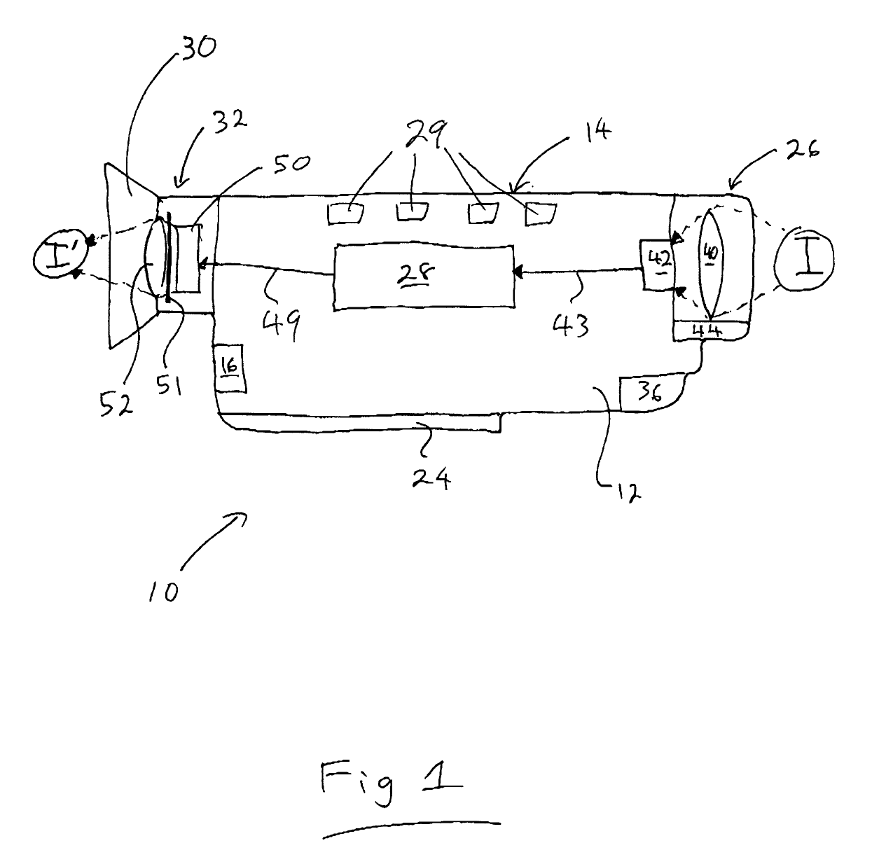

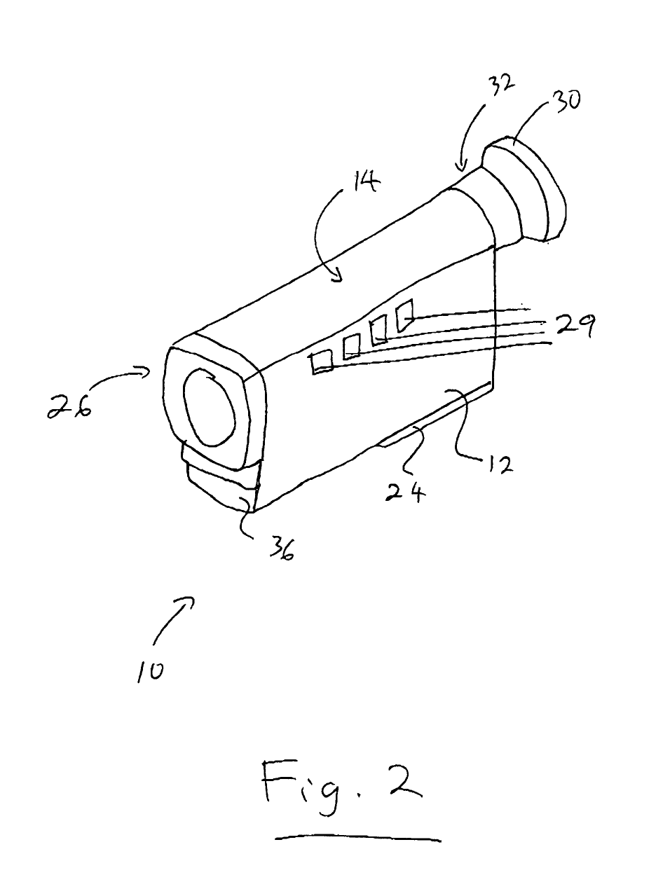

Referring now to FIGS. 1 and 2, a sight enhancement device 10 has a chassis or support frame 14 including a body 12. The chassis 14 is made from any suitable material such as metal or durable plastics such as ABS or a polycarbonate for extra shock resistance. It is preferred that the chassis 14 is light-weight and the body 12 can be shaped with a suitable ergonomic grip, if desired. The chassis 14 houses a power supply or battery 24, which can be rechargeable or disposable. The battery can be a lithium ion battery and retained by a series of clips onto the exterior of the body 22.

The body 22 houses a lens assembly 26 for acquiring a captured image. The lens assembly 26 refracts and/or reflects the object image I to the image sensor 42. The sensor 42 in turn converts the image I to the digital captured image signal 43, which is sent to a digital signal processor 28 (DSP). As will be discussed in greater detail below, the processor 28 performs one or more image processing operations to the signal 43 and presents an appropriately modified or enhanced digital image signal 49 to a user looking through a view finder 30, via a display assembly 32. The display assembly 32 projects the modified image I′ to the user's eye. The body 22 can also have an output interface 17 for directing output image signals, of the device 10 to a remote display device or signal processor.

The device 10 helps to support a person with vision impairment, due to adjacent target objects I being too small, too distant, or too poorly contrasted to be adequately perceived. The device 10 provides real-time image processing, further discussed below, with a variable zoom control to locate and magnify the target object I and use a contrast enhancement feature to clarify and therefore identify the object by producing the enhanced image I′. The device 10 has additional features that facilitate the real-time processing of object images I in adverse viewing situations, such as low light conditions and high levels of background light conditions. The device 10 helps the user to dynamically tune out distracting information present in the image I and concentrate on desirable features of the object I represented by the image I′, so as to facilitate object perception and recognition. The device 10 facilitates the use of digital processing technology through the digital processor 28 to provide enhancement of the image I, to produce the enhanced image I′ as perceived by the user, rather than using primarily static optical equipment to control modification and enhancement of the image I.

The body 22 of the device 10 further includes a plurality of user interface controls 29, such as but not limited to push buttons, potentiometers, encoders, slider controls, and/or a touch screen, which are used to vary the image processing functions of the processor 28. It should be noted that the controls 29 can be positioned in a variety of locations about the device 10 to accommodate the ergonomic or physical requirements of the user, and in particular can be incorporated into positions about the body 22 to allow operation of the device 10 with one hand of the user. The controls 29 can also include multiple processing functions associated with an individual control, such as but not limited to large buttons which can be highly contrasted from the main body 22. This arrangement can facilitate perception of the controls 29 on the body 22 by persons with vision impairment.

In situations where hand control using the controls 29 may not be desirable, an audio input device 16 can be used to process voice commands to control operation of the device 10. The body 22 can also house an audio output device 36 such as a speaker. The speaker 36 can be any suitable speaker or audio output device as will occur to those of skill in the art, and receives output from the processor 28 based on predetermined criteria, the details of which will be discussed in greater detail below. Speaker 36 can include a volume control in order to adjust the sound level emitted by the speaker 36. In other embodiments, speaker 36 can be a monophonic or stereophonic ear-piece to be attached to device 10 and worn by the user. It should be noted that the controls 29 could be automatically implemented by the processor 28, based on predefined criteria to produce the enhanced image 49 for the user.

The lens assembly 26 attached to the body 22 includes an objective lens 40 for acquiring or capturing an image I within its field, and projecting the image I onto the image sensor 42 of the assembly 26. It should be noted that a pinhole lens could also be used in place of the objective lens 40, The image sensor 42 can be an array or matrix of charge coupled devices (CCD), complementary metal oxide semi conductor (CMOS) image sensors or other means for converting image I into the digital signal 43 for processing by the processor 28. The image sensor 42 sends the digital signal 43 the representing a captured image of I to the processor 28 for digital enhancement. The assembly 26 can also include a lens control 44 for the lens 40, which can dynamically focus, zoom and control the iris. It should be noted, in the case of using a pinhole lens that focusing of the lens 40 is not employed. The lens control 44 can further include other features, such as a mechanical stabilizer for the captured image and the lens control 44 can receive commands from the processor 28 and feedback each of its various settings to the processor 28. This image sensor 42 can include analogue to digital other signal processing features, such as but not limited to those employed by the processor 28.

Once the processor 28 has processed the digital signal 43, to be explained below, the resulting enhanced signal 49 is directed to the display assembly 32. The display assembly 32 includes a reflective high-resolution micro-display 50, such as but not limited to an active matrix liquid crystal display (AMLCD) or a liquid crystal on silicon (LCOS) display by Colorado Microdisplay —Boulder Colo. The assembly 32 also contains an illuminator 51 to direct light onto the display 50 surface. The illuminator can be a semi-silvered surface oriented at 45 degrees to the display 50 surface. The user then looks through the lens 52, of the eyepiece 30, and through the illuminator 51 onto the display 50 surface, thereby perceiving the enhanced image 49 displayed thereon. It should be noted that the display 50 and illuminator 51 combination can be substituted by transmissive or emissive display devices, such as but not limited to light emitting organic devices, virtual retinal display devices, or electroluminescent displays. The orientation of the display 50 and lens 52 is preferably parallel or in-line to the orientation of the lens 40, thereby facilitating alignment of the device 10 in a direction consistent with the users line of sight.

The resolution of the display 50 for a particularly desired field of view is based on the density of pixels, the size of the pixels, and the viewing optics 52. It can be preferable to situate the display 50 as close to the lens 52 as possible in order to maximize the perceived field of view by the user. However, if the distance between the display 50 and the lens 52 is too small, pixelation can occur which degrades the image quality of the image I′ seen by the user. In one example embodiment, three minutes of arc per pixel with 2.5 microns per pixel provided to the user results in a 800×600 pixel resolution display 50 for persons with average low-vision capabilities.

The display 50 receives the enhanced digital image 49 from the processor 28 and projects the image I′ through the lens 52. The lens 52 can be dioptric and adjustable to allow for correction of refractive errors +/−3 dioptres. The lens 52 is employed to allow the user to focus on the upclose display 50, so as to provide an adequate field of view to the user greater than 30 degrees.

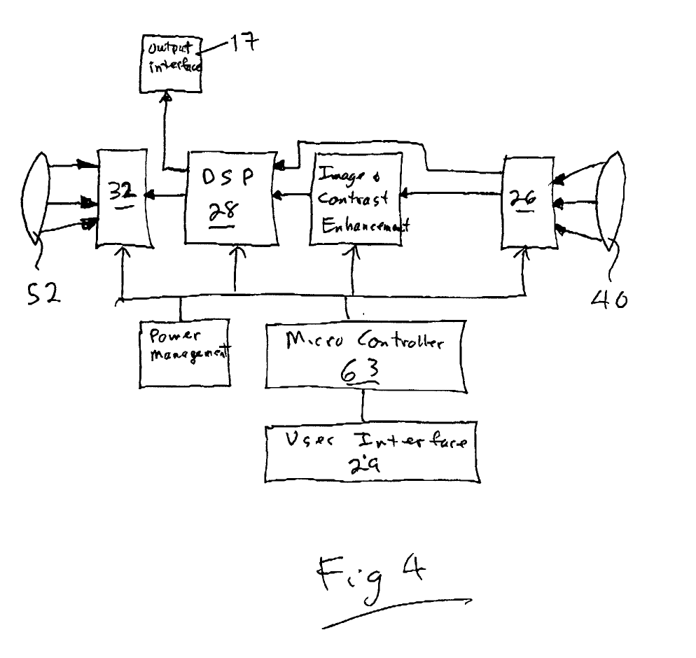

Referring FIG. 4, the Processor 28 includes a temporary digital storage 60, a disk storage 62, a micro-controller 63, a polarity reversal processing unit 64, a brightness processing unit 66, a colour processing unit 68, a contrast processing unit 70, a display driver 71, and a magnification unit 74. The processor 28 could also include a stabilization processing unit 72 and an optical character recognition (OCR) processing unit 76. It should be noted that all of these processing units could be represented as software modules run on the processor 28, or as individual hardware components, or a combination thereof

In the present embodiment, the temporary storage area 60 is a conventional random access memory having about 4 megabytes to permit subsequent processing of the image signal 43 by processor 28. The disk storage area 62 can be in EEPROM or another type of storage means such as but not limited to a smart card or flash memory.

The central processing unit 63 is a master controller for the processor 28 and is generally operable to direct inputs from the interface 29, monitor the battery level from the battery 24, send appropriate sounds to the speaker 36, and send control signals to the lens controller 44. The device 10 can also have a power management system 61 for monitoring standby power requirements and powerup as is known in the art.

The polarity reversal processing unit 64 can be used to perform a polarity reversal operation on the image signal 43. First, the signal 43 is converted into a black and white image and then all black pixels are inverted to white pixels and vise versa. This polarity reversed image 49 is then delivered to the display 50 and presented as projected image I′ to the lens 52. The polarity reversal process can permit people with low vision to read light text on a dark background, as most printed material is available as dark text on a light background.

The brightness processing unit 66 performs brightness operations on the signal 43, by increasing or decreasing the mean luminance of the signal 43 and presenting the varied image 49 to the display 50 as the projected image I′. This feature can be used by persons who experience excess brightness with a disproportionate impact on their contrast sensitivity, and/or for other viewing situations as will occur to those skilled in the art.

The colour processing unit 68 is used to remove the colour out of the signal 43 to produce an intermediate gray scale signal, as is known in the art. The intermediate signal can be enhanced by the contrast stretching unit 70, described below, and then the colour unit 68 then applies appropriate known interpolation routines to reblend the enhanced gray scale image back to the enhanced colour image signal 49, If desired by the user, the enhanced gray signal can be shown on the display 50.

The contrast stretching unit 70 facilitates the user to perform a contrast stretch or to make a contrast adjustment to a specific range of brightness or luminance of the signal 43. The contrast stretching unit 70 performs the contrast stretch of the range between the darkest and lightest parts of the signal 43 above a threshold value, such as a mean or median value selected from the range. The unit 70 can be used when the user wishes to discern two or more relatively dark shapes against a bright background, or when two or more relatively bright shapes are present against a black background. This is accomplished by performing on a pixel by pixel basis of making dark gray pixels darker and light gray pixels lighter until an adequate amount of contrast in the signal 43 is achieved, in response to an appropriate user preference. The user can control the amount of contrast stretch dynamically through the control interface 29, in order to provide the enhanced image 49 to a user specified specification. This helps to tailor the enhanced image 49 to the individual situation. The resolution of the image signal 43 can be degraded by this process, but contrast quality can be improved

The stabilizing processing unit 72 uses any conventional image stabilizing technique know in the art, helping to compensate for movements in the device 10 which may otherwise cause a unsteady capturing of the image I, resulting in an unsteady or blurry display of the projected image I′. The image stabilization 72 could also be performed through digital processing, whereby the entire image 43 would be shifted to compensate for movements of the device 10.

The magnification processing unit 74 allows the user to decrease or increase the magnification of the image I as it is presented as image I′, as desired. The processing unit 74 can interact with the lens controller 44 to cause lens 40 to zoom in or zoom out on an image I. The magnification of image I can also be accomplished by digital processing of the digital signal 43 by the processor 28. Accordingly, magnification processing unit 74 can perform a conventional digital magnification, in order to increase or decrease the size of the image I as it is presented on the projected image I′.

The optical character recognition (OCR) processing unit 76 can incorporate any optical character recognition operation known in the art. The user can send a text image I to the processing unit 76, which then can be used to process the image I and identify the characters within the text image I. These identified characters can then either be displayed as large text on the display 50. Alternately, by using a speech generation operation, the identified characters can be converted into speech and broadcast from the speaker 36. The disk storage 42 can be used to store comparative images to aid in the character recognition operation of specified objects contained in the image I.

In operation of the device 10, the target object image I is located by the lens 40 and captured by the image sensor 42. The sensor converts the image I into a digital image signal 43, consisting of a series of “still” frames representing a digital version of the image I. The series of frames contained in the signal 43 is sent to the DSP 28 and processed in real time to become the digitally enhanced signal 49. The processor 28 processes the signal 43 on a frame by frame basis, as the frames are read sequentially into the storage 60. It should be noted that use of the temporary storage 60 for frame processing facilitates the real time processing capabilities of the device 10.

The digital enhancement process of each frame by the processor 28 can include removing the colour contained in the signal 43 to produce an intermediate gray scale signal, contrast stretching of the gray scale signal to enhance the contrast of adjacent objects in the gray scale. signal, adding in levels to intensify black and white and gray scale variations, reblending of the colour back in to the gray scale signal by mapping the colour originally removed back to the corresponding pixels to produce the enhanced signal 49, and modifying by a pixel by pixel comparison and interpolation of the signal 49 to format the lower resolution signal to the higher resolution format compatible with the display 50. The added pixels can be filled in by monitoring the entire pixel map according to standard algorithms, in order to grow the low resolution enhanced image to the desired high resolution enhanced image 49 compatible with the display 50 resolution. The enhanced signal 49 is then displayed on the display 50 and focused on by the user through the illuminator 51, to produce the perceived image I′. The amount of digital enhancement of the signal 43 is monitored by the microcontroller 63, according to user input via the interface 29 and/or 16, or by preprogrammed logic contained in the processor 28. It should be noted that colour washout of the image 49 can occur if the contrast is overstretched, resulting from too many additional levels being added in to the existing signal 43.

The signal 49 is then processed by the display driver unit 71 of the processor 28 to monitor the image and synchronization of the colour illumination timing. The display driver 71 reads the signal 49 on a frame by frame basis. The display driver 71 causes the current frame to be displayed on the display 50 at a frequency of 60 Hz. The display driver 71 also synchronizes the flash display of the frame contents through a red-green-blue (RGB) colour filter as a front illumination through the illuminator 51, as described above. Three separate red hue, green hue, and blue hue coloured versions of the frame are shone on the top surface of the display 50 in a sequential manner, whereby the three separate RGB frames are cycled at a frequency of 180 Hz. Therefore, the display of the current enhanced frame of the signal 49 on the display 50 begins with the flash of the corresponding first red hued frame by the illuminator 51 and ends with termination of the display of the corresponding third blue hued frame. It should be noted that other frequencies and colour sequences can be used, if desired.

The device 10 facilitates sight enhancement through the primary use of digital image manipulation, having a viewing display 50 that is generally inline with a sensor/camera assembly 26 for capturing an image I. The inline configuration is preferable to assist the user to locate a desired image I as the device 10 is oriented in the same direction as the user's line of sight. The device 10 further includes a plurality of digital image processing units, such as but not limited to software algorithms, to allow the user to process the captured digital image signal 43 and project or display the processed image 49 to assist the user in perceiving the image I′, thereby enhancing or augmenting the user's visual capabilities. The contrast processing unit 70 helps to provide a contrast adjustment over a particular range of luminance, thereby allowing the user to discern two or more objects having a similar luminance which are otherwise dominated by the remainder of the image having a radically different luminance from the two or more objects.

It will be understood that the present invention can be readily incorporated into a binocular system by duplicating the features for the second eye of the viewer, whereby the distance between the eyes is compensated for as is known in the art. It will be apparent that such a device can provide depth of field and other information to the second eye of the viewer.

1. A computer image display device for digitally augmenting and displaying in substantially real time a captured image, the device comprising:
a) an image acquisition assembly for acquiring said captured image and producing a digital image representing said captured image;
b) a processor for digitally augmenting a selected characteristic of said digital image and to produce an augmented digital image;
c) a display assembly for displaying said augmented digital image.

2. A computer image display device according to claim 1 further comprising a support frame for assembling said image acquisition assembly, said processor, and said display assembly thereon.

3. A computer image display device according to claim 2, wherein said support frame is adapted for hand held use by a user of the device.

4. A computer image display device according to claim 3 further including a controller for monitoring the augmentation of said selected characteristic.

5. A computer image display device according to claim 4, wherein said controller is a user interface for providing dynamic control of the augmentation of said selected characteristic.

6. A computer image display device according to claim 2, wherein said display assembly includes a high resolution display.

7. A computer image display device according to claim 6, wherein said high resolution display is a liquid crystal on silecon display.

8. A computer image display device according to claim 6, wherein said high resolution display is selected from the group comprising reflective, emissive, and transmissive displays.

9. A computer image display device according to claim 6 further including an illuminator for front lighting said high resolution display.

10. A computer image display device according to claim 3, wherein said display assembly is adapted for near eye applications and said display assembly further includes a micro display and a lens for focusing an eye of said user onto a display surface of said micro display.

11. A computer image display device according to claim 10, wherein said micro display is a high resolution micro display.

12. A computer image display device according to claim 11 further including an illuminator for front lighting said display surface.

13. A computer image display device according to claim 1, wherein said processor further includes memory for temporary storage of said digital image during processing thereof.

14. A computer image display device according to claim 13, wherein said processor processes said digital image by employing functions selected from the group comprising polarity reversal, brightness, colour, contrast stretching, stabilization, magnification, and character recognition.

15. A computer image display device according to claim 14, wherein a level of the contrast stretching function is dynamically controlled by said user by a control interface coupled to said processor.
